(19) United States
(12) Patent Application Publication
(10) Pub. No.: US 2024/0276486 A1
(43) Pub. Date: Aug. 15, 2024

(54) TRANSMISSION OCCASION SKIPPING WITH OVERLAPPING RESOURCES

(71) Applicant: QUALCOMM Incorporated, San Diego, CA (US)

(72) Inventors: Ahmed ELSHAFIE, San Diego, CA (US); Alberto RICO ALVARINO, San Diego, CA (US); Huilin XU, Temecula, CA (US); Peter GAAL, San Diego, CA (US); Diana MAAMARI, San Diego, CA (US)

(21) Appl. No.: 18/169,196

(22) Filed: Feb. 14, 2023

(51) Int. Cl. H04W 72/1268; H04L 5/00; H04W 72/21

(52) U.S. Cl. CPC H04W 72/1268; H04L 5/0094; H04W 72/21

(57) ABSTRACT

Certain aspects of the present disclosure provide techniques for wireless communication at a user equipment (UE), comprising obtaining signaling indicating multiple configured grant (CG) configurations, wherein the multiple CG configurations configure CG occasions with overlapping resources, obtaining signaling indicating activation of the multiple CG configurations, outputting, for transmission, signaling indicating at least one CG configuration of the multiple CG configurations, and outputting, for transmission, a communication in a CG occasion of the at least one CG configuration.

### BACKGROUND

### Field of the Disclosure

Aspects of the present disclosure relate to wireless communications, and more particularly, to techniques for implementing transmission occasion skipping.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes obtaining signaling indicating multiple configured grant (CG) configurations, wherein the multiple CG configurations configure CG occasions with overlapping resources; obtaining signaling indicating activation of the multiple CG configurations; outputting, for transmission, signaling indicating at least one CG configuration of the multiple CG configurations; and outputting, for transmission, a communication in a CG occasion of the at least one CG configuration.

Another aspect provides a method for wireless communication at a network entity. The method includes outputting, for transmission, signaling indicating multiple CG configurations for a UE, wherein the multiple CG configurations configure CG occasions with overlapping resources; outputting, for transmission, signaling indicating activation of the multiple CG configurations; obtaining signaling indicating at least one CG configuration of the multiple CG configurations selected by the UE; and obtaining a communication from the UE in a CG occasion of the at least one CG configuration.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of periodic configured grant (CG) occasions.

FIG. 6 depicts an example of allocated resources for an uplink transmission.

FIG. 7 depicts an example call flow diagram depicting signaling between a user equipment (UE) and a network entity, in accordance with aspects of the present disclosure.

FIG. 8 graphically depicts multiple CG configurations having overlapping resources, in accordance with aspects of the present disclosure.

FIG. 9 depicts CG configurations with CG occasions having overlapping resources, in accordance with aspects of the present disclosure.

FIG. 10 depicts an example of CG occasions with overlapping resources defined by time and frequency offsets, in accordance with aspects of the present disclosure.

FIG. 11 depicts a method for wireless communications.

FIG. 12 depicts a method for wireless communications.

FIG. 13 depicts aspects of an example communications device.

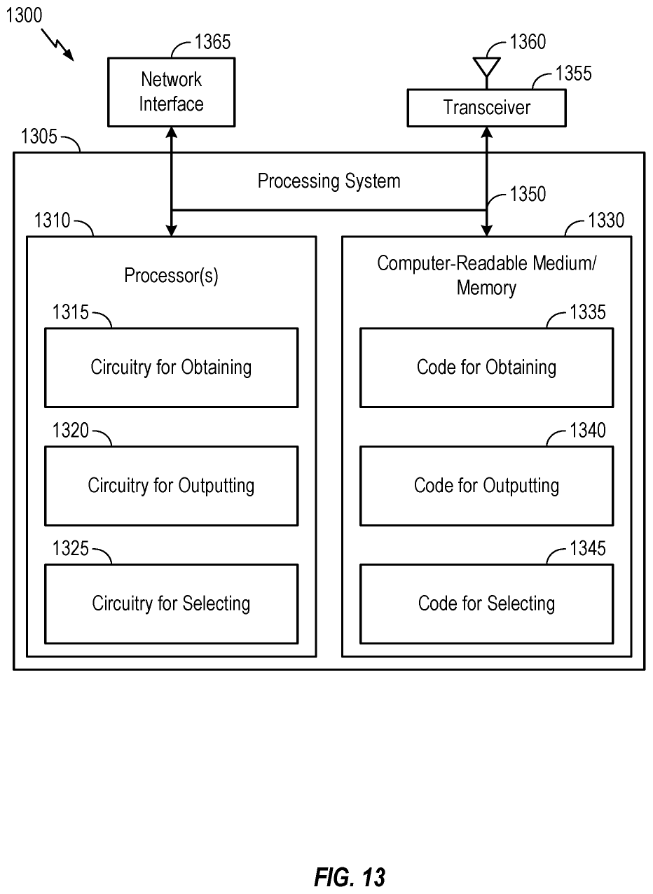

### DETAILED DESCRIPTION

Aspects of the present disclosure provide apparatuses, methods, processing systems, and computer-readable mediums for implementing transmission occasion skipping using multiple configured grant (CG) configuration with overlapping resources.

There are various signaling and scheduling mechanisms on which uplink (UL) transmission from a user equipment (UE) may be based. For example, an uplink transmission may be based on a scheduling request (SR) and buffer status report (BSR). In this case, the UE first transmits SR requesting radio resources in the UL when it has pending data in its buffer. Along with periodic BSR reporting, the network entity (e.g., gNB) knows the available buffer at UE (and when it needs to transmit data to avoid overflowing the buffer). The network allocates resources for the UE to transmit over. While this mechanism efficiently matches UL resource allocation to the amount of data (information bits) at the UE, it might result in increased latency as the UE transmits an SR and waits for an uplink grant.

Another mechanism is SR/BSR based with pre-scheduling. In this case, the UE does not need to repeatedly send SRs, as the network continues to schedule the UE until a configurable timer expires, after the UE has reported zero BSR (indicating the UE's buffers are empty). Resources may be allocated for this timer period, even when the UE has no more data to transmit. Another mechanism is periodic scheduling, where the network schedules uplink resources at a fixed periodicity, irrespective of UE buffer status. Still another mechanism is based on what is referred to as an uplink configured grant (UL-CG). When configured with an UL-CG, the UE has periodic UL resources available for transmission and is not required to receive an UL grant before transmission. The pre-scheduling periodic scheduling, and UL-CG based mechanisms generally result in lower latency. Unfortunately, over allocation of UL resources is also possible with these mechanisms.

Thus, the different scheduling mechanisms described above may be chosen to achieve tradeoffs in terms of latency, UL resources utilization and power consumption. With SR/BSR based scheduling, RB allocation in the UL may match the information bits. However, with UL-CG based scheduling, RB allocation might be more than what is needed for the UE information bits. This may require the UE to pad the information bits such that all the allocated resources to the UE are used. If the UE has no information bits (e.g., no packets pending) or fewer information bits, the UE may still be required to transmit over the allocated resources, resulting in inefficient resource utilization and increased power consumption.

Aspects of the present disclosure provide mechanisms for flexible uplink transmission skipping that allows a UE to select a CG configuration, from multiple CG configurations having CG occasions with overlapping resources, in an effort to optimize resource utilization. For example, the UE may be configured with first and second CG configurations, where the first CG configuration has CG occasions with larger resource allocation than the second CG configuration. In some cases, CG occasions of the second CG configuration may be a subset of resources of the CG occasions of the first CG configuration. The UE may select the first CG configuration if it has a large amount of data to transmit or may select the second CG configuration if it has a smaller amount of data to transmit. As a result, the techniques proposed herein may result in more efficient resource utilization and decreased power consumption.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

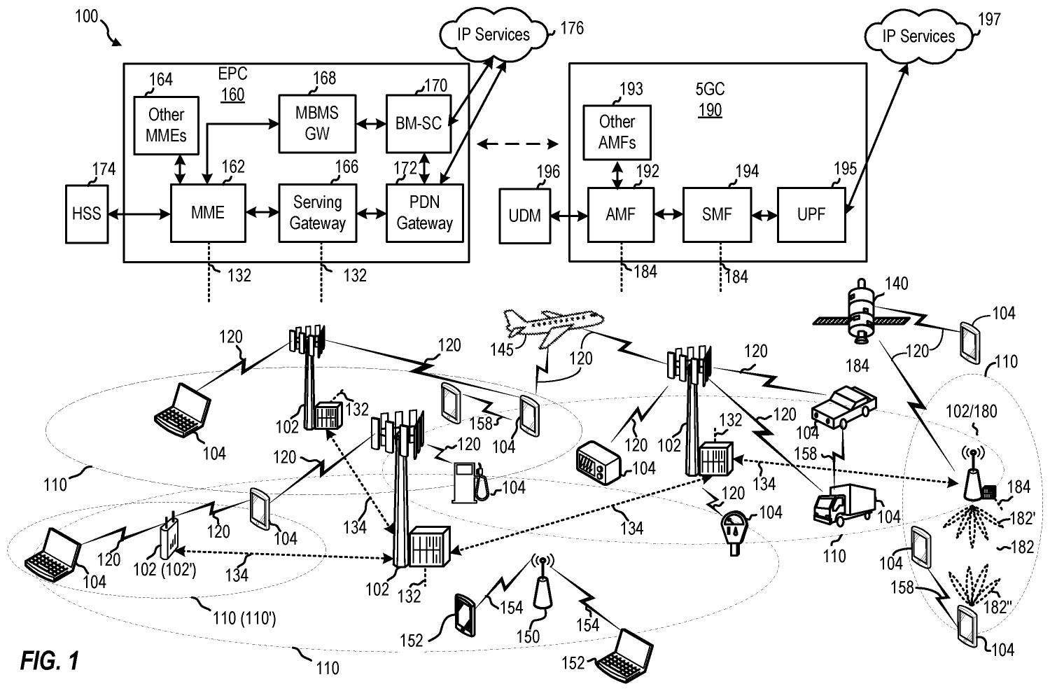

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

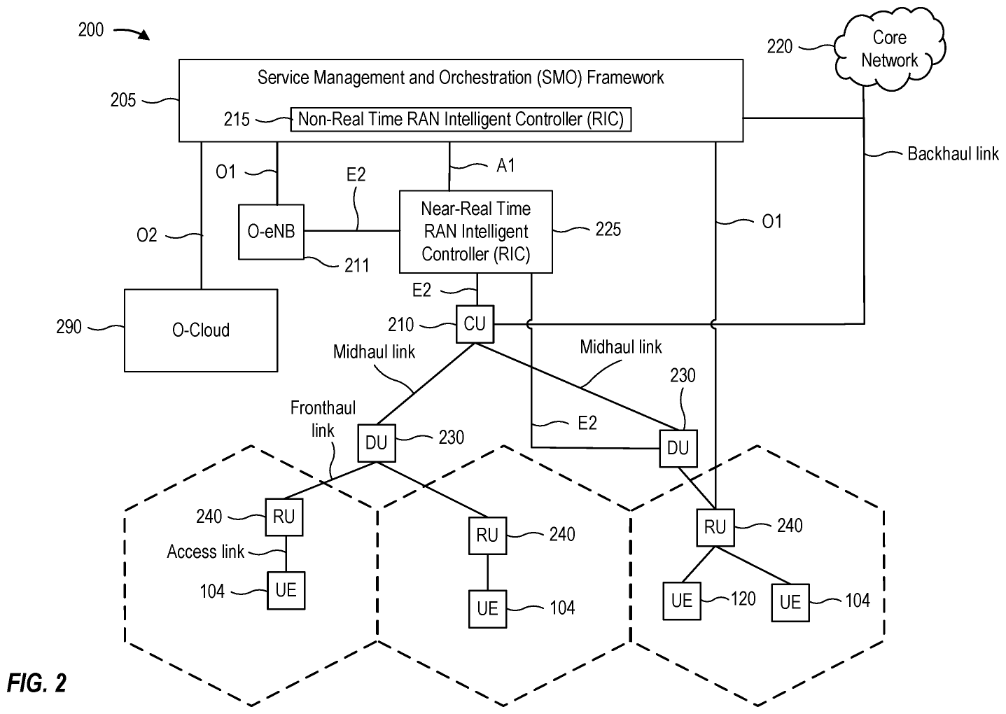

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

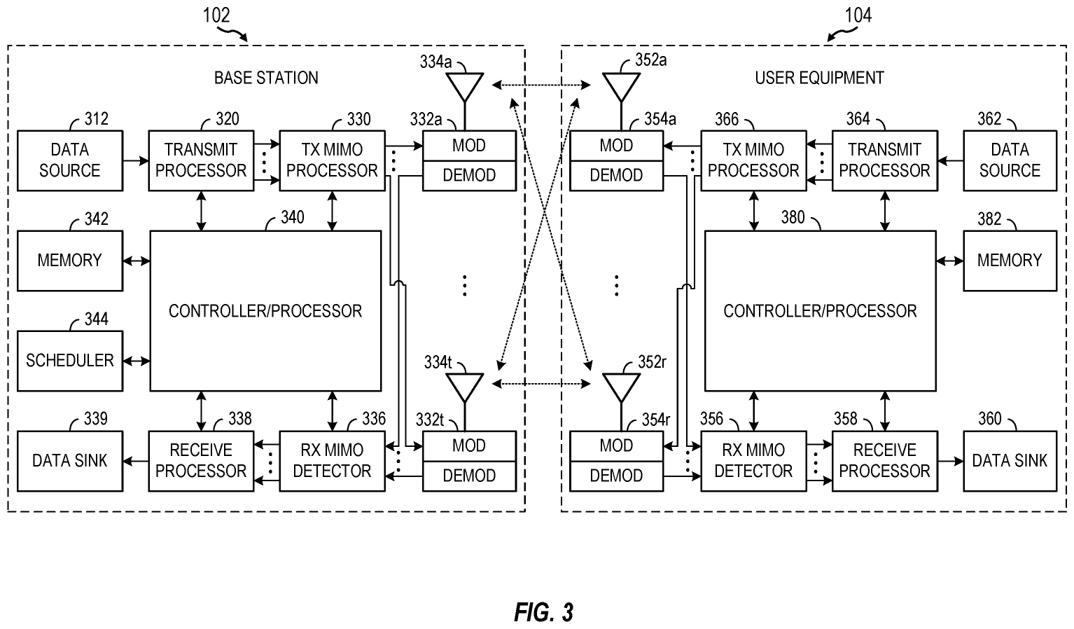

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

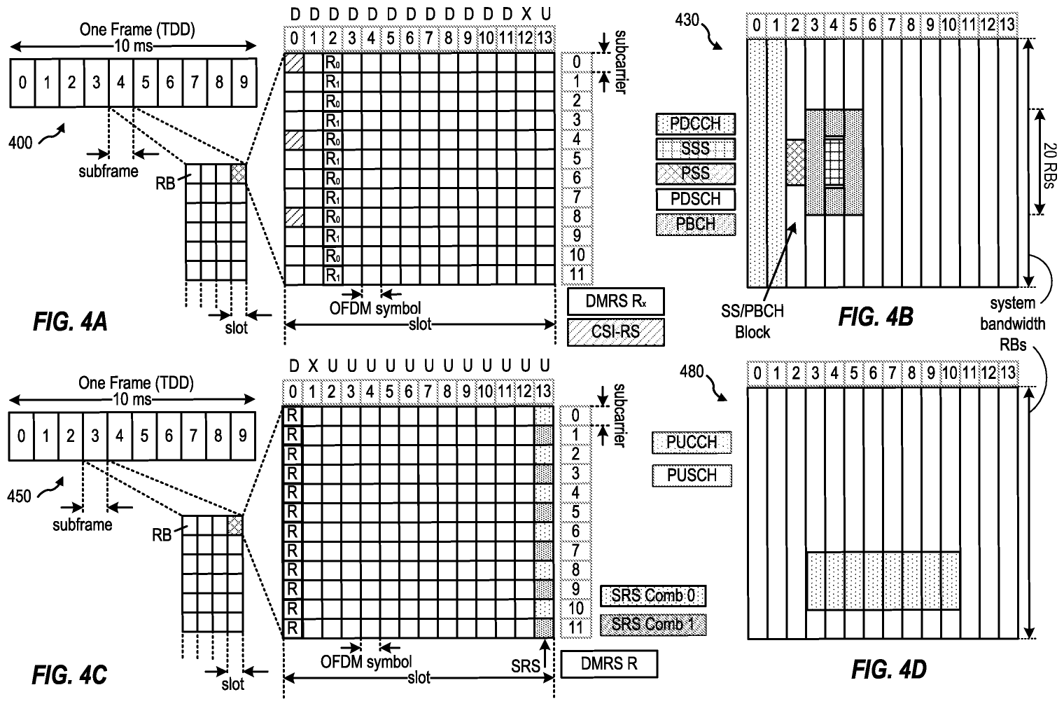

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Resource Allocations

Radio resources can be allocated to a UE by configured scheduling, dynamic scheduling, or a combination of configured and dynamic scheduling.

Configured scheduling is a mechanism in which the network can schedule PUSCH resources for the UE without using DCI to schedule each PUSCH transmission. Configured scheduling is done by configuring the UE with the scheduling parameters semi-statically in RRC signaling. Configured scheduling helps reduce the scheduling overhead.

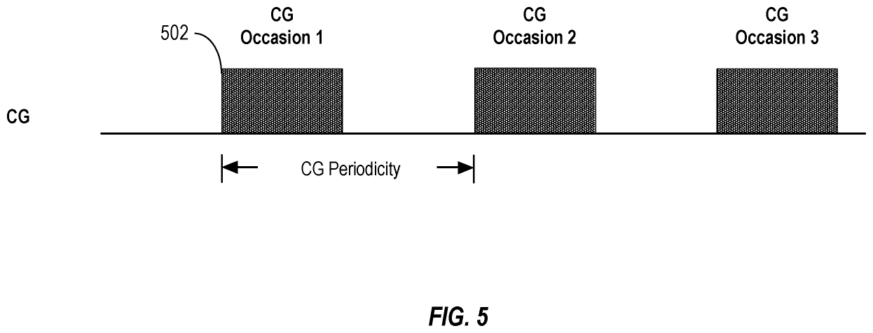

Configured scheduling for the uplink may be done using a configured grant (CG). FIG. 5 illustrates CG scheduling, where uplink resources are scheduled via CGs that occur periodically (referred to as CG occasions) without the need for control signaling, eliminating expense and delay associated with dynamic signaling. CG parameters are typically configured via RRC signaling and the activation of the grant is through RRC or L1 signaling. Typically, the periodicity and configured parameters (e.g., number of resource blocks (RBs), modulation and coding scheme (MCS), number of repetitions) are the same for all CG occasions in the CG configuration.

Two different types of configured grants include Type 1 CGs and Type 2 CGs. In Type 1 CG, the network send higher layer RRC signaling (e.g., an RRCSetup or RRCReconfiguration message according to 3GPP TS 38.331) configuring all the parameters for PUSCH scheduling including a resource allocation. The UE may transmit PUSCH according to configured scheduling, without receiving any lower layer trigger (e.g., DCI). In Type 2 CG, after the RRC configuration, the network sends a DCI (e.g., masked with a configured scheduling radio network temporary identifier (CS-RNTI)) to activate the configured grant. In both Type 1 CG and Type 2 CG, the network may send MAC CE signaling to downselect the RRC configured resources and/or DCI overwriting the configured scheduling. Because the configured scheduling is semi-static, the UE may be overallocated with resources for uplink transmission, for example, due to changed channel conditions.

For dynamic grants, the network may send DCI to schedule each uplink transmission for the UE. In some cases, the network schedules uplink resources for the UE based on buffer status reports (BSRs) received from the UE. However, if a BSR accurately reflecting the UEs buffer size is not recently received, the network may still overallocate resources for the UE. In addition, a BSR codepoint can correspond to a large range (e.g., 7-8 MB). In addition, a UE may first send a scheduling request (SR) for resources to send the BSR. SR and BSR transmission, and waiting for an uplink grant, may increase uplink latency at the UE.

### Overview of Partial Uplink Transmission

In some cases (e.g., in NR Release-15 and Rel-16 systems), such as when the UE is overallocated with resources for uplink transmission, the UE may perform partial uplink transmission. Partial uplink transmission allows a UE to skip (e.g., ignore, refrain from utilizing for transmission) allocated (whether dynamically or semi-statically configured) resources. Partial uplink transmission may also be referred to as uplink skipping.

In some aspects, skipping is configured at the UE (e.g., when an enhancedSkipUplinkTxDynamic or skipUplinkTxDynamic RRC parameter is set to true as described in 3GPP TS 38.822). In some cases, before the network configures flexible uplink transmission skipping, the network may confirm the UE supports such skipping. For example, a UE capability may be defined that indicates support of flexible UL skipping configuration. The UE capability may be exchanged after the UE has established an RRC connected mode with the network. In some cases, the capability may be separate for flexible skipping of UL resources associated with dynamic grants and configured grants. For example, the signaling for support of skipping for dynamic grants and configured grants may be different.

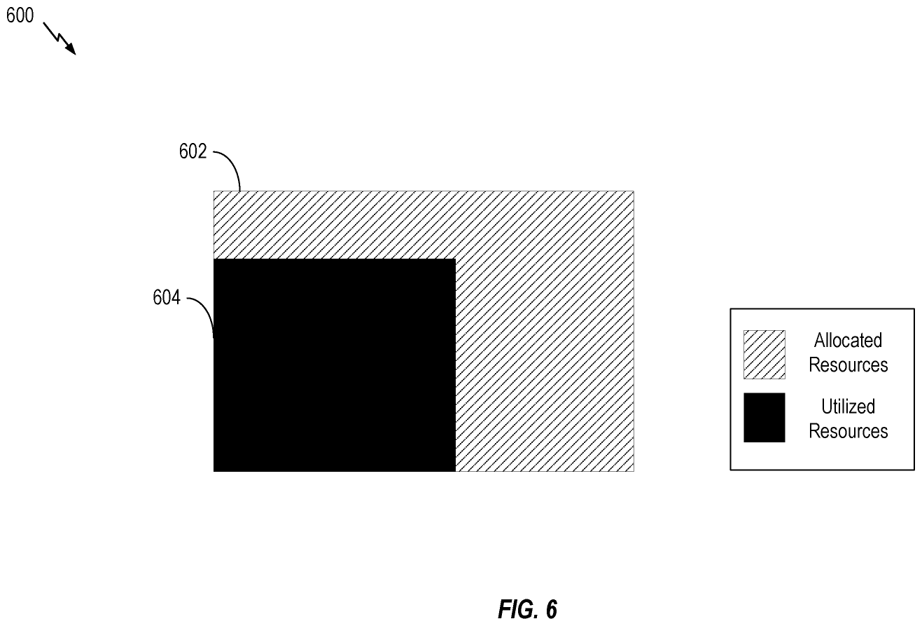

If skipping is configured at the UE and if the UE does not have sufficient data (e.g., a new MAC protocol data unit (PDU)) to transmit in the allocated uplink resources, or does not need all of the allocated uplink resource to transmit the data, the UE may skip all or a portion of the allocated resources. As shown in FIG. 6, for example, a UE with allocated resources 602 (e.g., a CG occasion with 50 available UL RBs in a 20 MHz system with a 30 kHz SCS) may transmit utilizing only a portion 604 of the allocated resource 602 (e.g., with a transport block size (TBS) for PUSCH requiring only 10 RBs). Alternatively, the UE can use all of the allocated resources for the uplink transmission, and adjust the MCS of the uplink transmission.

In some examples, rather than signal a precise set of RBs, a network entity may signal multiple sets of RBs that a UE may transmit on. The UE may pick one set to transmit on, while the BS may perform a search over each of the configured sets to identify the set of RBs the UE transmitted on.

In some examples, the network entity may signal a range of RBs over which the UE can transmit. The UE may select the particular number and set of RBs to use for transmission. For example, the particular number or set of RBs that the UE selects may be based on channel estimation or the number of information bits available. The UE may select a set of RBs that optimize UL throughput. For example, the UE may estimate the downlink channel and, based on channel reciprocity, estimate the uplink channel. The UE may select RBs that have favorable channel gain conditions. In some examples, a table may be defined (e.g., in a standard specification) that includes the TBS and the RBs allocation used.

Aspects Related to Transmission Resource Skipping with Overlapping Configured Grants

As noted above, if a network schedules a UE with a large grant of uplink resources (e.g., via DCI or CG), but then the UE has a very small amount of data to transmit, the UE may need to pad bits to use all the granted resources, which is very inefficient. Aspects of the present disclosure provide mechanisms for flexible uplink transmission skipping that allows a UE to select a CG configuration, from multiple CG configurations having CG occasions with overlapping resources, in an effort to optimize resource utilization.

With grant-free scheduling (e.g., via CG), resource allocation may be large and resource utilization high for some applications. As a result, power consumption and interference in the uplink may increase. The power consumption increase may increase the thermal condition of the UE, which may be incompatible with devices having a small form factor, such as extended reality (XR)/augmented reality (AR) devices.

As noted above, resource skipping may be utilized in some cases to improve resource utilization. For example, certain wireless standards have introduced medium access control (MAC) enhancements that may allow a UE to skip and/or ignore configured resources, whether the resources are dynamically or semi-statically allocated. This may reduce the need for a UE to transmit padded bits over the allocated resources (e.g., RBs) even though the information bits may not require the over-allocated number of RBs for transmission. Thus, a UE receiving a grant may either skip transmission over the grant (increasing latency if there are only a few bits to be transmitted) or utilize the full grant (increasing power consumption if it is a large grant).

Aspects of the present disclosure provide mechanisms for flexible uplink transmission skipping that allows a UE to select a CG configuration, from multiple CG configurations having CG occasions with overlapping resources, in an effort to optimize resource utilization.

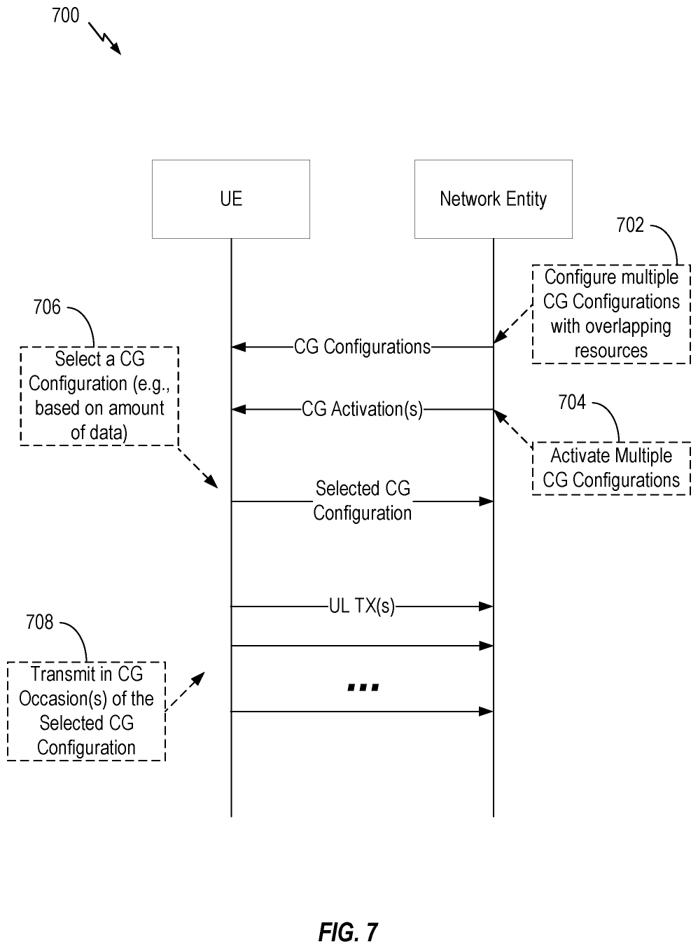

Flexible uplink transmission skipping in accordance with aspects of the present disclosure may be understood with reference to the call flow diagram 700 of FIG. 7. In some aspects, the network entity shown in FIG. 7 may be an example of the BS depicted and described with respect to FIGS. 1 and 3 or a disaggregated base station depicted and described with respect to FIG. 2. Similarly, the UE shown in FIG. 7 may be an example of UE 104 depicted and described with respect to FIGS. 1 and 3. However, in other aspects, UE 104 may be another type of wireless communications device and BS 102 may be another type of network entity or network node, such as those described herein.

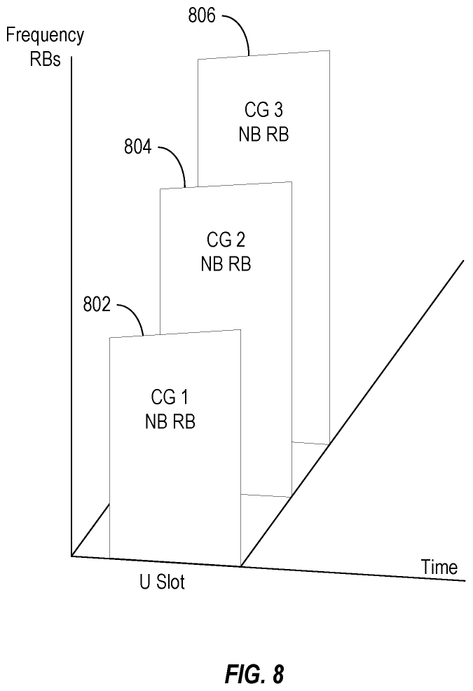

As illustrated at 702, the network entity configures the UE with multiple CG configurations with overlapping resources. The CG configurations could be from one or more groups of CG configurations. Example of CG configurations with overlapping resources are described below, with reference to FIGS. 8-10.

As illustrated at 704, the network entity may jointly activate (or reactivate) multiple CG configurations. In some cases, CG configurations may be jointly activated via a same RRC message (e.g., for type 1 CG) or via DCI (e.g., for type 2 CG). In the case of CG type 2, the network may send a single DCI indicating the CG configuration indices (individual indices) or indicating group ID of the group.

After activation of the multiple CG configurations, the UE selects a CG configuration, at 706. The UE indicates the selected CG configuration to the network entity. As shown at 708, the UE then transmits to the network entity in the CG occasion(s) of the selected CG configuration.

In some cases, when the network indicates CG group indices or groups indices, a UE may select a CG or CG group based on an evaluation of one or more parameters, such as transport block size (TBS), required reliability, remaining packet delay budget (PDB), modulation coding scheme (MCS), maximum or preferred transmit power at the UE, or the like.

In some cases, the network may indicate multiple CGs or CG groups, each associated with a set of parameters. The associated parameters may include, for example, at least one of range of TBS, reliability-related parameters, such as block error rate (BLER), latency or delay parameters, such as remaining PDB, L1/L2 priority, or quality of service (QOS) parameters. In such cases, the UE can then select a CG or CG group based on a known latency or delay parameter (e.g., PDB), logical channel (LCH) or logical channel group (associated with L2 priority), L1 priority, or traffic type (e.g., XR or ultra-reliable low latency communication URLLC).

In some cases, network configured CGs or CG groups may be associated with power/energy related parameters. In such cases, the UE can select a CG or CG group based on power/energy information, conditions, or states at the UE. In some cases, the selection may be based on a latest reported parameter (e.g., energy changing rate, energy discharging rate, energy level), energy conditions at the network (e.g., network energy state), or a maximum power that the UE can transmit with, based on its energy information, and/or MCS. In some cases, different parameters could be associated with different or a subset of CG configurations to be used by UE. Based on parameters known at the UE, the UE may selects one CG configuration or select none (e.g., and skip all).

In some cases, the selection may be based on an amount of data pending transmission. In other words, the UE may select a CG configuration with CG occasions that have an amount of resources appropriate for the amount of data. In this manner, the network may facilitate a more efficient use of resources by allocating two overlapping CG occasions.

For example, the network could configure a first CG configuration having CG occasions with 100 physical resource blocks (PRBs) and a second CG configuration with 20 PRBs, in (fully or partially) overlapping symbols. If a UE has a larger amount of data to transmit, the UE may select the larger CG occasion. Conversely, if the UE only has a small amount of data (or no data), the UE may select the smaller CG occasion.

As noted above, in some cases, the network may configure multiple CG configurations from one or more groups or sets of CG configurations. According to certain aspects, a network can group a set of CG configurations and configure these grouped CG configurations with a group identifier (ID) or group index. In this manner, a network may configure a group of CGs that include multiple CGs with CG occasions that have time and frequency resources which could overlap partially.

FIG. 8 illustrates an example of such a group of CG configurations, with frequency resources overlapping in a same uplink slot. CG1 802 uses fewer frequency resources than CG2 804, which in turn uses fewer resources than CG3 806. As indicated above, for activation, an index of a CG configuration and/or an index of a CG group may be indicated to the UE. If a group index is indicated, then a UE may implicitly know that it can select one CG configuration in the group (e.g., may select a CG occasion of that group). In some cases, the activation indication may indicate whether the activation is for a group indication or a single CG indication, so that correct UE behavior may be established.

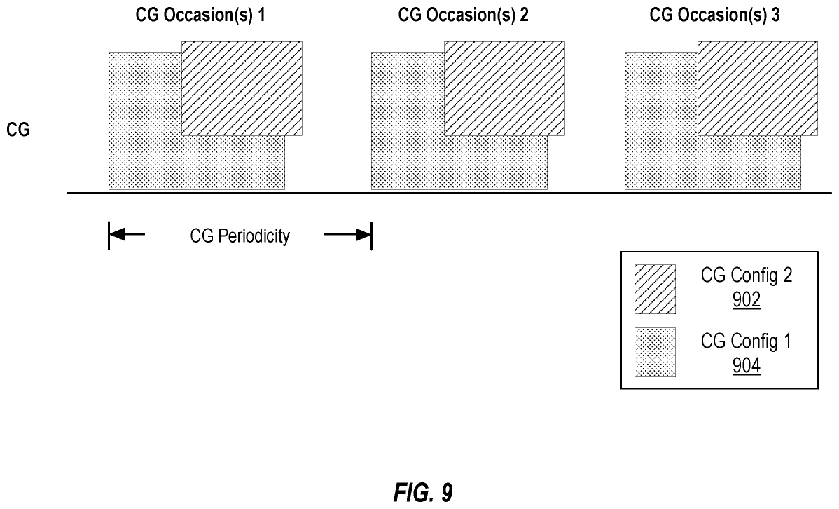

The UE may choose the CG configuration that best fits its payload size with a least amount of padding needed. For example, FIG. 9 illustrates two CG configurations, CG Config1 and CG Config2, with periodic CG occasions 902 and 904, respectively, that have overlapping time and frequency resources. CG occasions 904 for CG Config 1 are larger than CG occasions 902 for CG Config 2.

There are various options for how the UE may indicate which CG it has selected. For example, in certain cases, the UE may indicate a selected CG occasion (of selected CG configuration) to the network via uplink control information (UCI). In some cases, whether or not UCI is transmitted and/or a value of UCI may indicate the selected CG configuration. For example, no UCI transmission may indicate (e.g., as a default) that it selects the largest CG occasion for use. The UE may transmit a UCI value of “1” to the network if it selects the smaller CG occasion for use. Further, the UE may transmit a “0” if the UE does not select any CG occasion for use (no data transmission or full occasion skipping).

While the relatively simple example above assumes two CG configurations, with different CG occasion sizes, the concepts presented herein may be generalized to apply to N CG configurations, overlapping partially or fully in time and/or frequency resources on same slots.

According to certain aspects, a MAC control element (CE) type known at the network and the UE, may trigger and/or sub-select (down-select) a subset of CG configuration groups and at least one or more CG configurations within a group, for the UE to select. A BSR is one example of such a MAC CE.

In some cases, a first subset of activated CG configurations may be indicated by the outputting of the MAC CE, while a second subset of activated CG configurations may be indicated if the MAC CE is not output. In other words, the UE may indicate the first subset by actively transmitting the MAC CE, otherwise the UE implicitly indicates the second subset by not transmitting (refraining from transmitting) the MAC CE. Thus, the network entity may know the UE selected the first subset, if it receives the MAC CE or may conclude that the UE selected the second subset if the network entity does not receive the MAC CE.

Assuming an example where one CG group with two CG configurations is activated, for the UE to select from, if a MAC-CE is to be transmitted, the UE may transmit it on a CG configuration that is configured by network for such a purpose. In one example, the network may configure the UE to use CG Config 1 or CG Config 2 when a MAC-CE is transmitted or to use CG Config 1 or CG Config 3 when a MAC-CE is not transmitted. As another example, the network may let the UE choose between CG Config 1 and CG Config 2 if no MAC-CE is transmitted, and may expect the UE to use CG Config 1 if a MA-CE is transmitted.

In some cases, layer 1 (L1 or physical/PHY), layer 2 (L2 or MAC), and/or layer 3 (L3, such as RRC) signaled indications may be used for CG configuration/group activation or selection. In some cases, the indication of a CG configuration/group may be multiplexed with other information for transmission, such as channel state information (CSI), hybrid automatic repeat request acknowledgement (HARQ-ACK), scheduling request (SR), power headroom report (PHR), user assistance information (UAI), or random access channel (RACH) messages. Further, in some cases, down-selection of which CG configuration or CG configuration groups may be based on whether or not there is a certain signaling format (e.g., a MAC-CE or RRC) known at both the UE and network sides. As noted above, a BSR is one example of a MAC CE, while RRC reconfiguration and UAI are examples of RRC signaling.

In certain cases, up to 12 UL CGs (e.g., Type 1 and/or Type2) can be simultaneously activated on an active BWP. These UL CGs can be overlapped in time. In this case, a network may perform blind decoding to determine the CG used by the UE. In some cases, the network may schedule separate activation or deactivation for different UL-CG Type 2 configurations via DCI (e.g., Format 0_0, 0_1, 0_2) addressed by a configured scheduling (CS) radio network temporary identifier (CS-RNTI).

According to certain aspects, to enable greater flexibility, up to some maximum number (e.g., 12) of non-overlapping CG configurations may be configured per active bandwidth part (BWP). In other words, the constraint may be placed on the non-overlapping and all overlapping configurations are counted as one. Alternatively, the network may configure a maximum of 12 group/sets of CG configurations and define a maximum number of CG configurations per group. In other cases, there may be constraints on the number of overlapping CG configurations and non-overlapping CG configurations.

According to certain aspects, the network may configure at least one of a time offset or a frequency offset to be used by the UE to select the location of the selected CG configuration.

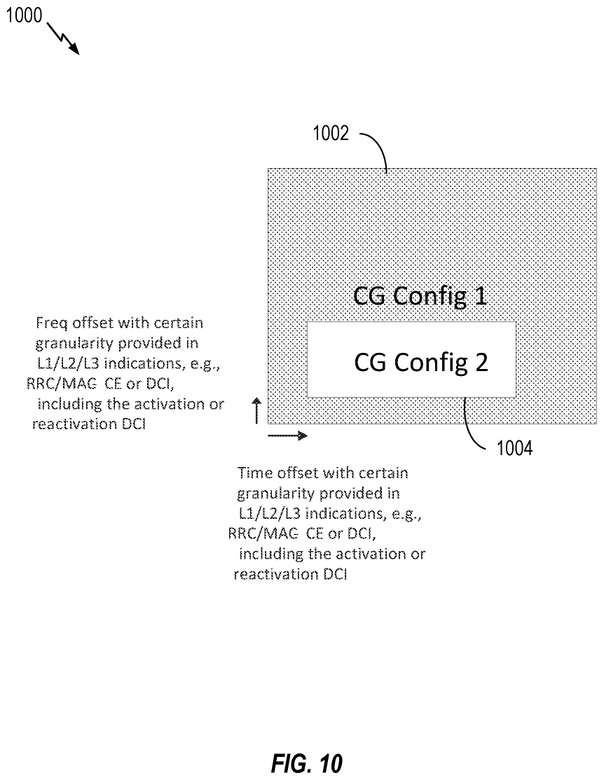

For example, FIG. 10 illustrates how selection of a CG occasion 1004 of CG Config2 may be indicated by time and frequency offsets relative to a CG occasion 1002 of CG Config 1. The UE may indicate the selected CG configuration/occasion by indicating the time offset and/or frequency offset. One or both of the time offset and frequency offset granularity can be configured per group and may depend on both NW and UE capabilities. The time and/or frequency offset may be configured via L1/L2/L3 indications (e.g., DCI, MAC CE, or RRC), including an activation DCI. In some cases, there may be a pairing between time offsets and frequency offsets, for example, based on NW and UE capabilities.

According to certain aspects, a CG configuration may belong to more than one group, in some cases, subject to a maximum (e.g., of X groups). The number of groups (that a CG configuration belongs to) can be based on network and/or UE capability and may be per band, per band comb, per component carrier (CC), or per CC comb. A UE may be configured with a maximum number of groups per BWP, for example, based on UE capability.

There are various options for how a UE may indicate which CG configurations/occasions are used or unused. In some cases, the UE may indicate a CG configuration used by the UE (a “used CG configuration”), for example, by providing an index value. In some cases, the UE may indicate which CG configuration the UE is to skip, for example, via a bitmap indicating skipped CG configurations within a group. The number of bits that the UE uses for such an indication may be log 2(N) where N is the number of CGs per group. Hence, the more CG configurations per group, the more bits may be sent.

As noted above, a UE may use various types of signaling (e.g., L1/L2/L3) to provide indications. For example, a UE may use an existing or new type of CG-UCI or other type of new UCI format or may multiplex indication with other types of information (e.g., CG-UCI, BSR, PHR, CSI, HARQ-ACK, RACH messages). In some cases, a UE may report skipping in multiple parts. For example, a UE may report a CG group index in a first part, then the UE may report a CG configuration (within the group) in a second part (and even indicate a time/frequency in a third part- or in the first part.

In some cases, UE indication may be provided via an existing BSR, which may achieve similar effects especially for XR video frame with large data size, if allowed. For example, if two CGs are configured, each with different amounts of resource for PUSCH transmission, a BSR sent at the first PUSCH occasion may imply which CG configuration to use at each PUSCH occasion. There may be different rules to select the proper CG configurations. One example of a rule may be to always use the CG configuration with wider bandwidth first, and select between the two CG configurations for a last PUSCH.

For a UCI based indication, if a CG UCI is used, there may be a default CG of the two CG configurations to use for the first PUSCH. This approach may avoid blind detection at the gNB. In one example, even if a video frame size is very small, the UE may still use a CG configuration with larger bandwidth.

As mentioned above, a UE may also apply a time and/or frequency offset to a selected CG occasion/configuration. To avoid blind decoding at gNB, the UE can also indicate the time offset of the selected CG occasion/configuration and frequency offset of the selected CG occasion/configuration as discussed above with respect to FIG. 10. In some cases, the UE may indicate a single codepoint that indicates the joint time/frequency offset applied (e.g., assuming there were defined tables/codebooks using L1/L2/L3 indications previously known to the UE).

According to certain aspects, the network may dynamically update a group configuration (e.g., size and/or CG indices of a CG configuration group) using L1/L2/L3 signaling. In some cases, the network may be allowed to deactivate a certain CG configuration within the group after activation.

According to certain aspects, the UE may indicate a CG configuration within the group to be deactivated/unused across a period of time (e.g., number of CG occasion periods). This indication may be provided via an L1/L2/L3 indication or combined L1/L2/L3 indications (e.g., including CSI, SR, HARQ-ACK, BSR, PHR, RACH messages).

In some cases, a UE may only indicate a CG configuration group it will use (e.g., and nothing else, such as a CG configuration within the group, in order to reduce signaling). In such cases, the network may perform blind decoding across the CG configurations (and parameters config of time/frequency) within the group. In this context, blind decoding at the network (e.g., gNB) may involve determining whether there is a signal or not, for example, based on DMRS associated with the PUSCH. In some cases, this type of reduced payload signaling may be enabled/disabled via L1, L2, or L3 signaling.

In some cases, there may be a defined timeline to multiplex after activation or reactivation of CG configurations. For example, through an RRC/MAC-CE/DCI (any L1/L2/L3 signaling) indication from the network, to the UE to indicate which signal to multiplex with or use and under what conditions. In some cases, an activation or reactivation DCI may be used for the CGs. In some cases, the method (of selecting/indicating a CG configuration) itself may be enabled or disabled based on L1/L2/L3 configuration or indication including using activation or reactivation DCI.

In some cases, the presence of a MAC-CE may result in down-selection of which CG group and/or which CG configuration within a selected group is selected. In some cases, the MAC-CE may indicate which CG group and/or CG configurations within a group is used. The MAC-CE may be any suitable type of MAC-CE, such as a BSR or any type of MAC-CE that is known at both the network and UE.

In some cases, a first one or more (X) CG occasion(s) may be deterministic. For example, a UE may use a certain CG configuration, or the UE may use a specific group or restricted group or groups and restricted CG configurations per group. In some cases, the UE may go down to restricting operation to one CG configuration within a deterministic (known) CG group. This can be for one CG occasion or the first X occasions, where X may be: 1) L1/L2/L3 configured before the DCI; or 2) indicated in the activation or reactivation DCI of the CGs. This type of behavior may be L1/L2/L3 activated, including activated in the activation or reactivation DCI of the CGs.

### Example Operations

FIG. 10 shows an example of a method 1000 of wireless communication at a UE, such as a UE 104 of FIGS. 1 and 3.

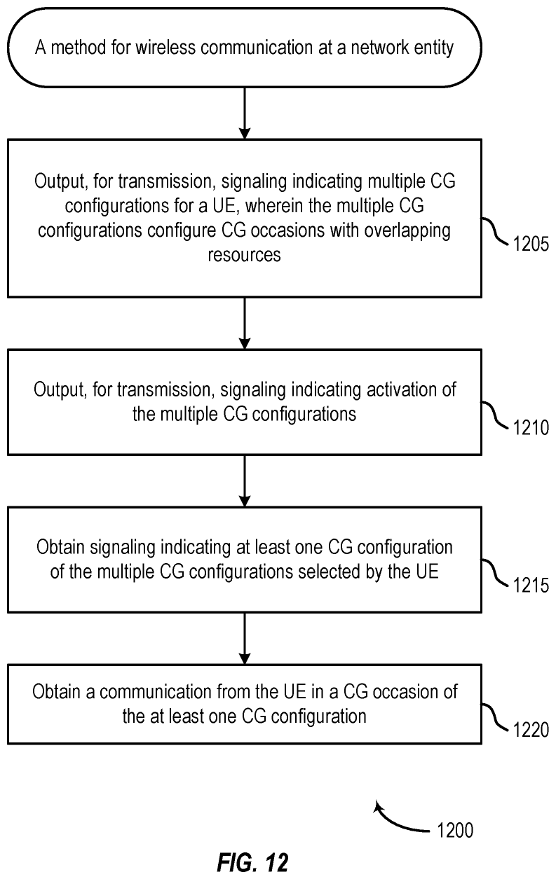

Method 1000 begins at step 1005 with obtaining signaling indicating multiple CG configurations, wherein the multiple CG configurations configure CG occasions with overlapping resources. In some cases, the operations of this step refer to, or may be performed by, circuitry for obtaining and/or code for obtaining as described with reference to FIG. 12.

Method 1000 then proceeds to step 1010 with obtaining signaling indicating activation of the multiple CG configurations. In some cases, the operations of this step refer to, or may be performed by, circuitry for obtaining and/or code for obtaining as described with reference to FIG. 12.

Method 1000 then proceeds to step 1015 with outputting, for transmission, signaling indicating at least one CG configuration of the multiple CG configurations. In some cases, the operations of this step refer to, or may be performed by, circuitry for outputting and/or code for outputting as described with reference to FIG. 12.

Method 1000 then proceeds to step 1020 with outputting, for transmission, a communication in a CG occasion of the at least one CG configuration. In some cases, the operations of this step refer to, or may be performed by, circuitry for outputting and/or code for outputting as described with reference to FIG. 12.

In some aspects, the signaling indicating activation of the multiple CG configurations comprises: control information or RRC signaling.

In some aspects, the multiple CG configurations configure CG occasions with resources overlapping partially or fully in at least one of time or frequency associated with same slots.

In some aspects, the signaling indicating the at least one CG configuration comprises UCI.

In some aspects, a value of the UCI is indicative of which CG configuration is being indicated.

In some aspects, the multiple CG configurations comprise a group of CG configurations having a group index.

In some aspects, the signaling indicating the at least one CG configuration comprises at least one of: physical layer signaling, a MAC-CE, or RRC signaling.

In some aspects, the signaling indicating the at least one CG configuration comprises: CSI, HARQ acknowledgment feedback, a SR, a PHR, a BSR, UAI, or a RACH transmission.

In some aspects, outputting the MAC CE indicates a first subset of the multiple CG configurations.

In some aspects, refraining from outputting the MAC CE indicates selection a second subset of the multiple CG configurations.

In some aspects, the method 1000 further includes obtaining signaling configuring the UE to support at least one of: a maximum number of active non-overlapping CG configurations per active BWP a maximum number of groups of CG configurations or a maximum number of CG configurations per group of CG configurations. In some cases, the operations of this step refer to, or may be performed by, circuitry for obtaining and/or code for obtaining as described with reference to FIG. 12.

In some aspects, the method 1000 further includes obtaining signaling configuring the UE with at least one offset in at least one of time or frequency. In some cases, the operations of this step refer to, or may be performed by, circuitry for obtaining and/or code for obtaining as described with reference to FIG. 12.

In some aspects, the method 1000 further includes selecting, based on the offset, a location of the at least one CG configuration. In some cases, the operations of this step refer to, or may be performed by, circuitry for selecting and/or code for selecting as described with reference to FIG. 12.

In some aspects, the multiple CG configurations comprise a number of one or more groups of CG configurations and at least one of: one or more of the CG configurations belong to multiple groups; a CG configuration can belong to a maximum number of groups; the number of groups is based on a capability of at least one of the UE or a network entity; the number of groups is per band, band comb, CC, or CC comb; or the UE is configured with a maximum number of groups per BWP based on UE capability.

In some aspects, the at least one CG configuration of the multiple CG configurations comprises at least one of: at least one CG configuration used by the UE; or one or more CG configurations skipped by the UE.

In some aspects, the indication of the at least one CG configuration is multiplexed with other information for transmission.

In some aspects, the signaling indicating at least one CG configuration of the multiple CG configurations indicates at least one of: a time offset of the at least one CG configuration or a CG occasion thereof; a frequency offset of the at least one CG configuration or a CG occasion thereof; or a codepoint jointly indicating a time offset and a frequency offset of the at least one CG configuration or a CG occasion thereof.

In some aspects, the method 1000 further includes obtaining signaling at least one of: updating the multiple CG configurations or activating or deactivating at least one of the multiple CG configurations. In some cases, the operations of this step refer to, or may be performed by, circuitry for obtaining and/or code for obtaining as described with reference to FIG. 12.

In some aspects, the method 1000 further includes outputting, for transmission, signaling indicating one or more of the multiple CG configurations to be unused by the UE for a period of time. In some cases, the operations of this step refer to, or may be performed by, circuitry for outputting and/or code for outputting as described with reference to FIG. 12.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

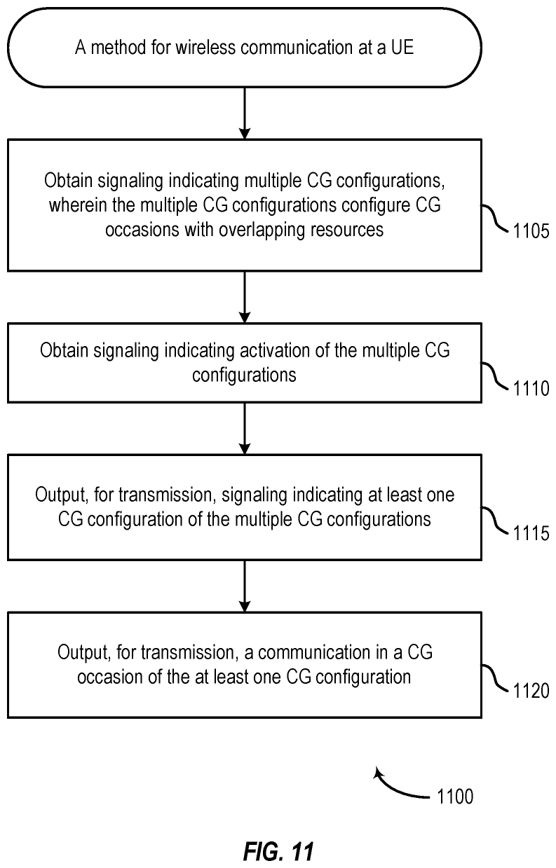

FIG. 11 shows an example of a method 1100 of wireless communication at a network entity, such as a BS 102 of FIGS. 1 and 3, or a disaggregated base station as discussed with respect to FIG. 2.

Method 1100 begins at step 1105 with outputting, for transmission, signaling indicating multiple CG configurations for a UE, wherein the multiple CG configurations configure CG occasions with overlapping resources. In some cases, the operations of this step refer to, or may be performed by, circuitry for outputting and/or code for outputting as described with reference to FIG. 12.

Method 1100 then proceeds to step 1110 with outputting, for transmission, signaling indicating activation of the multiple CG configurations. In some cases, the operations of this step refer to, or may be performed by, circuitry for outputting and/or code for outputting as described with reference to FIG. 12.

Method 1100 then proceeds to step 1115 with obtaining signaling indicating at least one CG configuration of the multiple CG configurations selected by the UE. In some cases, the operations of this step refer to, or may be performed by, circuitry for obtaining and/or code for obtaining as described with reference to FIG. 12.

Method 1100 then proceeds to step 1120 with obtaining a communication from the UE in a CG occasion of the at least one CG configuration. In some cases, the operations of this step refer to, or may be performed by, circuitry for obtaining and/or code for obtaining as described with reference to FIG. 12.

In some aspects, the signaling indicating activation of the multiple CG configurations comprises: control information or RRC signaling.

In some aspects, the multiple CG configurations configure CG occasions with resources overlapping partially or fully in at least one of time or frequency associated with same slots.

In some aspects, the signaling indicating the at least one CG configuration comprises UCI.

In some aspects, a value of the UCI is indicative of which CG configuration is being indicated.

In some aspects, the multiple CG configurations comprise a group of CG configurations having a group index.

In some aspects, the signaling indicating the at least one CG configuration comprises at least one of: physical layer signaling, a MAC-CE, or RRC signaling.

In some aspects, the signaling indicating the at least one CG configuration comprises: CSI, HARQ acknowledgment feedback, a SR, a PHR, a BSR, UAI, or a RACH transmission.

In some aspects, obtaining the MAC CE indicates a first subset of the multiple CG configurations.

In some aspects, an absence of the MAC CE indicates selection a second subset of the multiple CG configurations.

In some aspects, the method 1100 further includes outputting, for transmission, signaling configuring the UE to support at least one of: a maximum number of active non-overlapping CG configurations per active BWP a maximum number of groups of CG configurations or a maximum number of CG configurations per group of CG configurations. In some cases, the operations of this step refer to, or may be performed by, circuitry for outputting and/or code for outputting as described with reference to FIG. 12.

In some aspects, the method 1100 further includes outputting, for transmission, signaling configuring the UE with at least one offset in at least one of time or frequency. In some cases, the operations of this step refer to, or may be performed by, circuitry for outputting and/or code for outputting as described with reference to FIG. 12.

In some aspects, the multiple CG configurations comprise a number of one or more groups of CG configurations and at least one of: one or more of the CG configurations belong to multiple groups; a CG configuration can belong to a maximum number of groups; the number of groups is based on a capability of at least one of the UE or a network entity; the number of groups is per band, band comb, CC, or CC comb; or the UE is configured with a maximum number of groups per BWP based on UE capability.

In some aspects, the at least one CG configuration of the multiple CG configurations comprises at least one of: at least one CG configuration used by the UE; or one or more CG configurations skipped by the UE.

In some aspects, the indication of the at least one CG configuration is multiplexed with other information obtained from the UE.

In some aspects, the signaling indicating at least one CG configuration of the multiple CG configurations indicates at least one of: a time offset of the at least one CG configuration or a CG occasion thereof; a frequency offset of the at least one CG configuration or a CG occasion thereof; or a codepoint jointly indicating a time offset and a frequency offset of the at least one CG configuration or a CG occasion thereof.

In some aspects, the method 1100 further includes outputting, for transmission, signaling at least one of: updating the multiple CG configurations or activating or deactivating at least one of the multiple CG configurations. In some cases, the operations of this step refer to, or may be performed by, circuitry for outputting and/or code for outputting as described with reference to FIG. 12.

In some aspects, the method 1100 further includes obtaining signaling indicating one or more of the multiple CG configurations to be unused by the UE for a period of time. In some cases, the operations of this step refer to, or may be performed by, circuitry for obtaining and/or code for obtaining as described with reference to FIG. 12.

In one aspect, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative steps are possible consistent with this disclosure.

### Example Communications Device

FIG. 12 depicts aspects of an example communications device 1200. In some aspects, communications device 1200 is a user equipment, such as UE 104 described above with respect to FIGS. 1 and 3. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1255 (e.g., a transmitter and/or a receiver). In some aspects (e.g., when communications device 1200 is a network entity), processing system 1205 may be coupled to a network interface 1265 that is configured to obtain and send signals for the communications device 1200 via communication link(s), such as a backhaul link, midhaul link, and/or fronthaul link as described herein, such as with respect to FIG. 2. The transceiver 1255 is configured to transmit and receive signals for the communications device 1200 via the antenna 1260, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, cause the one or more processors 1210 to perform the method 1000 described with respect to FIG. 10, or any aspect related to it; and the method 1100 described with respect to FIG. 11, or any aspect related to it. Note that reference to a processor performing a function of communications device 1200 may include one or more processors 1210 performing that function of communications device 1200.

In the depicted example, computer-readable medium/memory 1230 stores code (e.g., executable instructions), such as code for obtaining 1235, code for outputting 1240, and code for selecting 1245. Processing of the code for obtaining 1235, code for outputting 1240, and code for selecting 1245 may cause the communications device 1200 to perform the method 1000 described with respect to FIG. 10, or any aspect related to it; and the method 1100 described with respect to FIG. 11, or any aspect related to it.

The one or more processors 1210 include circuitry configured to implement (e.g., execute) the code stored in the computer-readable medium/memory 1230, including circuitry for obtaining 1215, circuitry for outputting 1220, and circuitry for selecting 1225. Processing with circuitry for obtaining 1215, circuitry for outputting 1220, and circuitry for selecting 1225 may cause the communications device 1200 to perform the method 1000 described with respect to FIG. 10, or any aspect related to it; and the method 1100 described with respect to FIG. 11, or any aspect related to it.

Various components of the communications device 1200 may provide means for performing the method 1000 described with respect to FIG. 10, or any aspect related to it; and the method 1100 described with respect to FIG. 11, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1255 and the antenna 1260 of the communications device 1200 in FIG. 12. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1255 and the antenna 1260 of the communications device 1200 in FIG. 12. Means for refraining and/or means for selecting may include any of the processors shown in FIG. 3.

### Example Clauses

Implementation examples are described in the following numbered clauses:

Clause 1: A method for wireless communication at a user equipment (UE), comprising: obtaining signaling indicating multiple configured grant (CG) configurations, wherein the multiple CG configurations configure CG occasions with overlapping resources; obtaining signaling indicating activation of the multiple CG configurations; outputting, for transmission, signaling indicating at least one CG configuration of the activated multiple CG configurations; and outputting, for transmission, a communication in a CG occasion of the at least one CG configuration.

Clause 2: The method of Clause 1, wherein the signaling indicating activation of the multiple CG configurations comprises: control information or a radio resource control (RRC) signaling.

Clause 3: The method of Clause 2, further comprising selecting the at least one CG configuration, from the activated multiple CG configurations, based on at least one of a transport block size (TBS), a reliability related parameter, a delay related parameter, a priority related parameter, a quality of service (QOS) type, or a traffic type.

Clause 4: The method of any one of Clauses 1-3, wherein the multiple CG configurations configure CG occasions with resources overlapping partially or fully in at least one of time or frequency associated with same slots.

Clause 5: The method of any one of Clauses 1-4, wherein the signaling indicating the at least one CG configuration comprises uplink control information (UCI).

Clause 6: The method of Clause 5, wherein a value of the UCI is indicative of which CG configuration is being indicated.

Clause 7: The method of any one of Clauses 1-6, wherein the multiple CG configurations comprise a group of CG configurations having a group index.

Clause 8: The method of any one of Clauses 1-7, wherein the signaling indicating the at least one CG configuration comprises a physical layer signaling, a medium access control (MAC) control element (CE), or radio resource control (RRC) signaling.

Clause 9: The method of Clause 8, wherein: a first subset of the activated multiple CG configurations is indicated by the outputting of the MAC CE.

Clause 10: The method of any one of Clauses 1-9, wherein the signaling indicating the at least one CG configuration comprises: a dedicated uplink control information (UCI) resource to be transmitted in a physical uplink control channel (PUCCH) or physical uplink shared channel (PUSCH), UCI, CG-UCI, modified CG-UCI, channel state information (CSI), hybrid automatic repeat request (HARQ) acknowledgment feedback, a scheduling request (SR), a power headroom report (PHR), a buffer status report (BSR), user assistance information (UAI), or a random access channel (RACH) transmission.

Clause 11: The method of any one of Clauses 1-10, further comprising obtaining signaling configuring the UE to support at least one of: a maximum number of active non-overlapping CG configurations per active bandwidth part (BWP); a maximum number of groups of CG configurations; or a maximum number of CG configurations per group of CG configurations.

Clause 12: The method of any one of Clauses 1-11, further comprising: obtaining signaling configuring the UE with at least one offset in at least one of time or frequency; and selecting, based on the offset, a location of the at least one CG configuration.

Clause 13: The method of any one of Clauses 1-12, wherein the multiple CG configurations comprise a number of one or more groups of CG configurations and at least one of: one or more of the CG configurations belong to multiple groups; a CG configuration can belong to a maximum number of groups; the number of groups is based on a capability of at least one of the UE or a network entity; the number of groups is per band, band comb, component carrier (CC), or CC comb; or the UE is configured with a maximum number of groups per bandwidth part (BWP) based on UE capability.

Clause 14: The method of any one of Clauses 1-13, wherein the at least one CG configuration of the multiple CG configurations comprises at least one of: at least one CG configuration used by the UE; or one or more CG configurations skipped by the UE.

Clause 15: The method of Clause 14, wherein the indication of the at least one CG configuration is multiplexed with other information for transmission.

Clause 16: The method of any one of Clauses 1-15, wherein the signaling indicating at least one CG configuration of the multiple CG configurations indicates at least one of: a time offset of the at least one CG configuration or a CG occasion thereof; a frequency offset of the at least one CG configuration or a CG occasion thereof; a codepoint jointly indicating a time offset and a frequency offset of the at least one CG configuration or a CG occasion thereof; or a group of CG configurations, including the at least one CG configuration.

Clause 17: The method of any one of Clauses 1-16, further comprising obtaining signaling at least one of: updating the multiple CG configurations; or activating or deactivating at least one of the multiple CG configurations.

Clause 18: The method of any one of Clauses 1-17, further comprising outputting, for transmission, signaling indicating one or more of the multiple CG configurations to be unused by the UE for a period of time.

Clause 19: A method for wireless communication at a network entity, comprising: outputting, for transmission, signaling indicating multiple configured grant (CG) configurations for a user equipment (UE), wherein the multiple CG configurations configure CG occasions with overlapping resources; outputting, for transmission, signaling indicating activation of the multiple CG configurations; obtaining signaling indicating at least one CG configuration of the multiple CG configurations selected by the UE; and obtaining a communication from the UE in a CG occasion of the at least one CG configuration.

Clause 20: The method of Clause 19, wherein the signaling indicating activation of the multiple CG configurations comprises: control information or radio resource control (RRC) signaling.

Clause 21: The method of any one of Clauses 19-20, wherein the multiple CG configurations configure CG occasions with resources overlapping partially or fully in at least one of time or frequency associated with same slots.

Clause 22: The method of any one of Clauses 19-21, wherein the signaling indicating the at least one CG configuration comprises uplink control information (UCI).

Clause 23: The method of Clause 22, wherein a value of the UCI is indicative of which CG configuration is being indicated.

Clause 24: The method of any one of Clauses 19-22, wherein the multiple CG configurations comprise a group of CG configurations having a group index.

Clause 25: The method of any one of Clauses 19-23, wherein the signaling indicating the at least one CG configuration comprises physical layer signaling, a medium access control (MAC) control element (CE), or radio resource control (RRC) signaling.

Clause 26: The method of Clause 25, wherein a first subset of the activated multiple CG configurations is indicated by the obtaining of the MAC CE.

Clause 27: The method of any one of Clauses 19-26, wherein the signaling indicating the at least one CG configuration comprises: channel state information (CSI), hybrid automatic repeat request (HARQ) acknowledgment feedback, a scheduling request (SR), a power headroom report (PHR), a buffer status report (BSR), user assistance information (UAI), or a random access channel (RACH) transmission.

Clause 28: The method of any one of Clauses 19-27, further comprising outputting, for transmission, signaling configuring the UE to support at least one of: a maximum number of active non-overlapping CG configurations per active bandwidth part (BWP); a maximum number of groups of CG configurations; or a maximum number of CG configurations per group of CG configurations.

Clause 29: The method of any one of Clauses 19-28, further comprising: outputting, for transmission, signaling configuring the UE with at least one offset in at least one of time or frequency.

Clause 30: The method of any one of Clauses 19-29, wherein the multiple CG configurations comprise a number of one or more groups of CG configurations and at least one of: one or more of the CG configurations belong to multiple groups; a CG configuration can belong to a maximum number of groups; the number of groups is based on a capability of at least one of the UE or a network entity; the number of groups is per band, band comb, component carrier (CC), or CC comb; or the UE is configured with a maximum number of groups per bandwidth part (BWP) based on UE capability.

Clause 31: The method of any one of Clauses 19-30, wherein the at least one CG configuration of the multiple CG configurations comprises at least one of: at least one CG configuration used by the UE; or one or more CG configurations skipped by the UE.

Clause 32: The method of Clause 31, wherein the indication of the at least one CG configuration is multiplexed with other information obtained from the UE.

Clause 33: The method of any one of Clauses 19-32, wherein the signaling indicating at least one CG configuration of the multiple CG configurations indicates at least one of: a time offset of the at least one CG configuration or a CG occasion thereof; a frequency offset of the at least one CG configuration or a CG occasion thereof; or a codepoint jointly indicating a time offset and a frequency offset of the at least one CG configuration or a CG occasion thereof.

Clause 34: The method of any one of Clauses 19-33, further comprising outputting, for transmission, signaling at least one of: updating the multiple CG configurations; or activating or deactivating at least one of the multiple CG configurations.

Clause 35: The method of any one of Clauses 19-34, further comprising obtaining signaling indicating one or more of the multiple CG configurations to be unused by the UE for a period of time.

Clause 36: An apparatus, comprising: a memory comprising executable instructions; and a processor configured to execute the executable instructions and cause the apparatus to perform a method in accordance with any one of Clauses 1-35.

Clause 37: An apparatus, comprising means for performing a method in accordance with any one of Clauses 1-35.

Clause 38: A non-transitory computer-readable medium comprising executable instructions that, when executed by a processor of an apparatus, cause the apparatus to perform a method in accordance with any one of Clauses 1-35.

Clause 39: A computer program product embodied on a computer-readable storage medium comprising code for performing a method in accordance with any one of Clauses 1-35.

Clause 40: A user equipment (UE), comprising: at least one transceiver; a memory comprising instructions; and one or more processors configured to execute the instructions and cause the UE to perform a method in accordance with any one of Clauses 1-18, wherein the at least one transceiver is configured to receive the signaling indicating multiple CG configurations.

Clause 41: A network entity, comprising: at least one transceiver; a memory comprising instructions; and one or more processors configured to execute the instructions and cause the network entity to perform a method in accordance with any one of Clauses 19-35, wherein the at least one transceiver is configured to transmit the signaling indicating multiple CG configurations.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising: a memory comprising instructions; and one or more processors configured to execute the instructions and cause the apparatus to:
obtain, by a user equipment (UE), signaling indicating multiple configured grant (CG) configurations, wherein the multiple CG configurations configure CG occasions with overlapping resources;
obtain signaling indicating activation of the multiple CG configurations;
output, for transmission, signaling indicating at least one CG configuration of the activated multiple CG configurations; and
output, for transmission, a communication in a CG occasion of the at least one CG configuration.

2. The apparatus of claim 1, wherein the signaling indicating activation of the multiple CG configurations comprises: control information or a radio resource control (RRC) signaling.

3. The apparatus of claim 2, wherein the one or more processors are further configured to execute the instructions and cause the apparatus to select the at least one CG configuration, from the activated multiple CG configurations, based on at least one of a transport block size (TBS), a reliability related parameter, a delay related parameter, a priority related parameter, a quality of service (QOS) type, or a traffic type.

4. The apparatus of claim 1, wherein the multiple CG configurations configure CG occasions with resources overlapping partially or fully in at least one of time or frequency associated with same slots.

5. The apparatus of claim 1, wherein the signaling indicating the at least one CG configuration comprises uplink control information (UCI).

6. The apparatus of claim 5, wherein a value of the UCI is indicative of which CG configuration is being indicated.

7. The apparatus of claim 1, wherein the multiple CG configurations comprise a group of CG configurations having a group index.

8. The apparatus of claim 1, wherein the signaling indicating the at least one CG configuration comprises a physical layer signaling, a medium access control (MAC) control element (CE), or radio resource control (RRC) signaling.

9. The apparatus of claim 8, wherein:
a first subset of the activated multiple CG configurations is indicated by the outputting of the MAC CE.

10. The apparatus of claim 1, wherein the signaling indicating the at least one CG configuration comprises: a dedicated uplink control information (UCI) resource to be transmitted in a physical uplink control channel (PUCCH) or physical uplink shared channel (PUSCH), UCI, CG-UCI, modified CG-UCI, channel state information (CSI), hybrid automatic repeat request (HARQ) acknowledgment feedback, a scheduling request (SR), a power headroom report (PHR), a buffer status report (BSR), user assistance information (UAI), or a random access channel (RACH) transmission.

11. The apparatus of claim 1, wherein the one or more processors are further configured to execute the instructions and cause the apparatus to obtain signaling configuring the UE to support at least one of:
a maximum number of active non-overlapping CG configurations per active bandwidth part (BWP);
a maximum number of groups of CG configurations; or
a maximum number of CG configurations per group of CG configurations.

12. The apparatus of claim 1, wherein the one or more processors are further configured to execute the instructions and cause the apparatus to:
obtain signaling configuring the UE with at least one offset in at least one of time or frequency; and
select, based on the offset, a location of the at least one CG configuration.

13. The apparatus of claim 1, wherein the multiple CG configurations comprise a number of one or more groups of CG configurations and at least one of:
one or more of the CG configurations belong to multiple groups;
a CG configuration can belong to a maximum number of groups;
the number of groups is based on a capability of at least one of the UE or a network entity;
the number of groups is per band, band comb, component carrier (CC), or CC comb; or
the UE is configured with a maximum number of groups per bandwidth part (BWP) based on UE capability.

14. The apparatus of claim 1, wherein the at least one CG configuration of the multiple CG configurations comprises at least one of:
at least one CG configuration used by the UE; or
one or more CG configurations skipped by the UE.

15. The apparatus of claim 14, wherein the indication of the at least one CG configuration is multiplexed with other information for transmission.

16. The apparatus of claim 1, wherein the signaling indicating at least one CG configuration of the multiple CG configurations indicates at least one of:
a time offset of the at least one CG configuration or a CG occasion thereof;
a frequency offset of the at least one CG configuration or a CG occasion thereof; or
a codepoint jointly indicating a time offset and a frequency offset of the at least one CG configuration or a CG occasion thereof.

17. The apparatus of claim 1, further comprising at least one transceiver, wherein the at least one transceiver is configured to receive signaling indicating multiple CG configurations, and the apparatus is configured as a UE.

18. An apparatus for wireless communication at a network entity, comprising a memory comprising instructions; and one or more processors configured to execute the instructions and cause the apparatus to:
output, for transmission, signaling indicating multiple configured grant (CG) configurations for a user equipment (UE), wherein the multiple CG configurations configure CG occasions with overlapping resources;
output, for transmission, signaling indicating activation of the multiple CG configurations;
obtain signaling indicating at least one CG configuration of the multiple CG configurations selected by the UE; and
obtain a communication from the UE in a CG occasion of the at least one CG configuration.

19. The apparatus of claim 18, wherein the signaling indicating activation of the multiple CG configurations comprises: control information or radio resource control (RRC) signaling.

20. The apparatus of claim 18, wherein the multiple CG configurations configure CG occasions with resources overlapping partially or fully in at least one of time or frequency associated with same slots.

21. The apparatus of claim 18, wherein the signaling indicating the at least one CG configuration comprises uplink control information (UCI).

22. The apparatus of claim 18, wherein the multiple CG configurations comprise a group of CG configurations having a group index.

23. The apparatus of claim 18, wherein the signaling indicating the at least one CG configuration comprises physical layer signaling, a medium access control (MAC) control element (CE), or radio resource control (RRC) signaling.

24. The apparatus of claim 18, wherein the signaling indicating the at least one CG configuration comprises: channel state information (CSI), hybrid automatic repeat request (HARQ) acknowledgment feedback, a scheduling request (SR), a power headroom report (PHR), a buffer status report (BSR), user assistance information (UAI), or a random access channel (RACH) transmission.

25. The apparatus of claim 18, wherein the one or more processors are further configured to execute the instructions and cause the apparatus to output, for transmission, signaling configuring the UE to support at least one of:
a maximum number of active non-overlapping CG configurations per active bandwidth part (BWP);
a maximum number of groups of CG configurations; or
a maximum number of CG configurations per group of CG configurations.

26. The apparatus of claim 18, wherein the one or more processors are further configured to execute the instructions and cause the apparatus to:
output, for transmission, signaling configuring the UE with at least one offset in at least one of time or frequency.

27. The apparatus of claim 18, wherein the multiple CG configurations comprise a number of one or more groups of CG configurations and at least one of:
one or more of the CG configurations belong to multiple groups;
a CG configuration can belong to a maximum number of groups;
the number of groups is based on a capability of at least one of the UE or a network entity;
the number of groups is per band, band comb, component carrier (CC), or CC comb; or
the UE is configured with a maximum number of groups per bandwidth part (BWP) based on UE capability.

28. The apparatus of claim 18, wherein the at least one CG configuration of the multiple CG configurations comprises at least one of:
at least one CG configuration used by the UE; or
one or more CG configurations skipped by the UE.

29. The apparatus of claim 18, further comprising at least one transceiver, wherein the at least one transceiver is configured to transmit the signaling indicating multiple CG configurations, and the apparatus is configured as a network entity.

30. A method for wireless communication at a user equipment (UE), comprising:
obtaining signaling indicating multiple configured grant (CG) configurations, wherein the multiple CG configurations configure CG occasions with overlapping resources;
obtaining signaling indicating activation of the multiple CG configurations;
outputting, for transmission, signaling indicating at least one CG configuration of the activated multiple CG configurations; and
outputting, for transmission, a communication in a CG occasion of the at least one CG configuration.
